(19) United States
(12) Patent Application Publication
(10) Pub. No.: US 2011/0123121 A1
(43) Pub. Date: May 26, 2011

(54) METHOD AND SYSTEM FOR REDUCING BLOCKING ARTEFACTS IN COMPRESSED IMAGES AND VIDEO SIGNALS

(75) Inventors: Paul Springer, Stuttgart (DE); Oliver Erdler, Ostfildern-Ruit (DE); Martin Richter, Dortmund (DE); Carsten Dolar, Hannover (DE)

(73) Assignee: Sony Corporation, Tokyo (JP)

(21) Appl. No.: 12/895,037

(22) Filed: Sep. 30, 2010

(30) Foreign Application Priority Data
Oct. 13, 2009 (EP) 09172919.4

(51) Int. Cl. G06K 9/40; G06K 9/48

(52) U.S. Cl. 382/199; 382/260

(57) ABSTRACT

The present invention relates to a coding parameter independent method for reduction of blocking artefacts in a compressed image or video signal. For this purpose, the image is analysed in the vicinity of the block boundaries in order to measure the existence and strength of blocking artefacts and to detect image areas. Based on the analysis result map information for each pixel adjacent to a block boundary is generated. The filter mode for each block boundary is adaptively determined dependent on the map information and the image is filtered depending on the chosen filter mode.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC

Not Applicable

### BACKGROUND OF THE INVENTION

(1) Field of the Invention

The present invention relates to a method and system for reducing blocking artefacts in compressed image and video signals. More specifically, the present invention relates to a coding parameter independent reduction of blocking artefacts using image analysis and content adaptive filtering of block boundaries.

There are many different approaches for blocking artefact reduction in video processing. Typically one can distinguish methods which operate in spatial domain (e.g. simple adaptive or non-adaptive low-pass filtering at block boundaries) and methods which operate in a transform domain (e.g. wavelet domain). Furthermore, one can differentiate coding parameter dependent methods, which adapt filter strategies based on e.g. quantization level of blocks and methods independent from coding parameters, which are either not image content adaptive or are using an image analysis to distinguish e.g. flat, texture or edge areas at block boundaries.

In video compression often a transform domain processing is used to efficiently store or transmit the information. The discrete cosine transform (DCT) is an example of an intra-frame video compression algorithm, where single frames of a video sequence are processed with a block-based transform scheme. Most of the information contained in video signals is concentrated in the low frequency part of the spectrum. In video processing a DCT based compression can be efficiently used to store this information. A compression effect can be reached via either strong quantization or truncation of high signal frequencies. This lossy compression leads to visible coding artefacts especially present at block boundaries, the so called “blocking artefact”. Main target of the mentioned methods is to overcome this artefact. This can be reached e.g. with a simple low-pass filtering in the vicinity of the block boundary, where e.g. a step function is converted into a smoothed ramp function.

In case of edge or texture area within the vicinity of the block boundary, a degradation of image content is apparent if a low-pass filtering is applied. Thus high-quality deblocking methods use content adaptive filter strategies to overcome a degradation of image content. The adaptive filtering can be controlled via coding parameters or based on an image analysis. A coding parameter dependent deblocking approach could e.g. use the quantization level to adapt the filter strength. If quantization level is high, filtering could be strong and vice versa. A high-quality coding parameter independent deblocking approach could e.g. use a flat vs. edge vs. texture discrimination to detect blocking artefact and/or control filtering strength. If blocking artefact is apparent and block boundary lies within a homogeneous area, a strong low-pass filtering could be applied, otherwise no or weak filtering could be carried out.

Transform domain methods are often applied to separate image information from coding degradation (e.g. blocking) in the transform domain. A deblocking method using wavelet transform makes use of the fact that degradation and image information often lie within different sub-bands. Thus a truncation (coring) of coefficients in some sub-bands could be used to reduce image degradation (e.g. blocking).

(2) Description of Related Art including information disclosed under 37 CFR 1.97 and 1.98.

Not applicable

### BRIEF SUMMARY OF THE INVENTION

It is therefore the object of the present invention to improve the prior art.

In a first aspect the present invention relates to a method for reduction of blocking artefacts in compressed image and video signals, comprising the steps of analyzing the image in the vicinity of the block boundaries in order to measure the existence and strength of blocking artefacts and to detect image areas, generating map information for each pixel adjacent to a block boundary based on the analysis result, determining the filter mode for each block boundary dependent on the map information and filtering the image depending on the chosen filter mode.

According to a second aspect, the present invention relates to a system for reduction of blocking artefacts in compressed image and video signals, an analyzer for analyzing the image in the vicinity of the block boundaries in order to measure the existence and strength of blocking artefacts and to detect image areas and for generating map information for each pixel adjacent to a block boundary based on the analysis result, and a filter which is adapted to determine the filter mode for each block boundary dependent on the map information and to filter the image depending on the chosen filter mode.

According to a further aspect, the present invention relates to a computer program product stored on a computer readable medium which causes a computer to perform the steps of analyzing the image in the vicinity of the block boundaries in order to measure the existence and strength of blocking artefacts and to detect image areas, generating map information for each pixel adjacent to a block boundary based on the analysis result, and determining the filter mode for each block boundary dependent on the map information and filtering the image depending on the chosen filter mode.

### BRIEF DESCRIPTION OF THE SEVERAL VIEWS OF THE DRAWINGS

The present invention will now be explained in more detail in the following description of the preferred embodiments in relation to the enclosed drawings in which

FIG. 1 shows a schematic block diagram of a system according to the present invention,

FIG. 2 shows a schematic block diagram of a component of the system according to the present invention,

FIGS. 3a to 3c show examples of map information at different processing points during the process according to the present invention,

FIGS. 4 to 7 show examples of pixels used for analysing the image according to the present invention,

FIG. 8 is a flow chart showing the process steps of a block boundary gradient analysis according to the present invention,

FIG. 9 is an example of a short-pass deblocking filter,

FIG. 10 is an example of a long-pass deblocking filter, and

FIG. 11a and FIG. 11b are a flow chart showing the process steps according to the method of the present invention.

### DETAILED DESCRIPTION OF THE INVENTION

The present invention relates to an improved method and system for block noise reduction in compressed images. The term “image” according to the present invention is intended to refer to any type of still or moving image, specifically is intended to refer to still images or video sequences. Even though the term “image” will be used throughout the whole specification, it is not intended to limit the scope of protection but to cover with the present invention any type of image or video material.

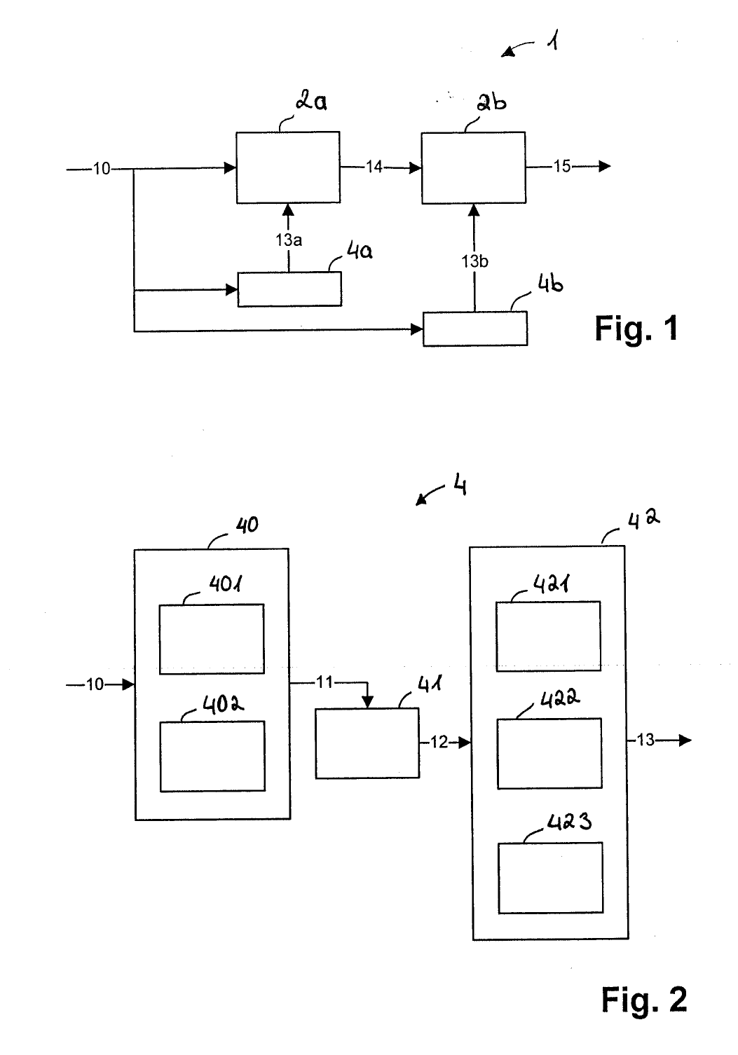

FIG. 1 shows a schematic block diagram of a system for reducing blocking artefacts in a compressed image according to the present invention. The present invention bases on a coding parameter independent approach, thus a block boundary based image analysis is applied to protect details from sharpness loss and adapt the low-pass coefficients of the deblocking filter locally.

For this purpose the input image 10 is submitted to a filter 2 and to an image analyser 4. In the embodiment as shown in FIG. 1, hereby two image analysers 4a, 4b for image analysis in horizontal and vertical direction are provided and correspondingly two filters 2a, 2b for filtering in horizontal and vertical direction are provided. However, it is also possible to combine the horizontal image analyser 4a and the vertical image analyser 4b into one single component. Likewise it is possible to combine the horizontal filter 2a and the vertical filter 2b into one single filter component.

As shown in FIG. 1 the input image 10 is submitted to the horizontal filter 2a, the horizontal image analyser 4a and the vertical image analyser 4b. The image analysers 4a, 4b analyse the image in the vicinity of the block boundaries in order to measure the level or strength of blocking artefacts and in order to detect image areas. Based on the analysis result a detection map is generated having map information for each pixel adjacent to a block boundary.

More specifically, the image analysers 4a, 4b assign a value to a detection map at the position of each pixel adjacent to every block boundary. This map information 13 is then submitted to the corresponding filter 2a, 2b in order to determine the filter mode for each block boundary. Hereby, as shown in FIG. 1, horizontal map information 13a is transmitted from the horizontal image analyser 4a to the horizontal filter 2a, and likewise vertical map information 13b is transmitted from the vertical image analyser 4b to the vertical filter 2b.

The horizontal filter 2a after having received the input image 10 as well as the horizontal map information 13a determines the filter mode for the horizontal block boundaries dependent on the horizontal map information 13a. The horizontal filter 2a then transmits the intermediate filtered image 14 to the vertical filter 2b, which in turn performs vertical filtering and determines the filter mode for each vertical block boundary dependent on the vertical map information 13b received by the vertical image analyser 4b.

The filtered, i.e. deblocked output image 15 is then output by the vertical filter 2b.

It is noted that the order can of course be changed so that first the vertical filtering is accomplished and afterwards the horizontal filtering.

In the present invention thus an improved analysis is accomplished which measures the strength of blocking artefact and at the same time detects image areas. Depending on the analysis an adaptive deblocking filter is used.

According to the present invention the detection of the image areas comprises detection of three different image areas, namely edges, textured areas and homogeneous or flat areas within the image. The present invention thus allows to differentiate between the different image areas in order to distinguish image information from image degradation. This allows a more accurate deblocking with respect to other methods, which only analyse the image with respect to one or two different areas and which are not able to detect three different area types.

As filter modes a long deblocking filter, a short deblocking filter or a bypass with no filtering at all are provided. Apart from the improved analysis the present invention therefore provides a very differentiated filter mode decision. However, the present invention is not limited to three filter modes, but can also comprise two, three or more filter modes.

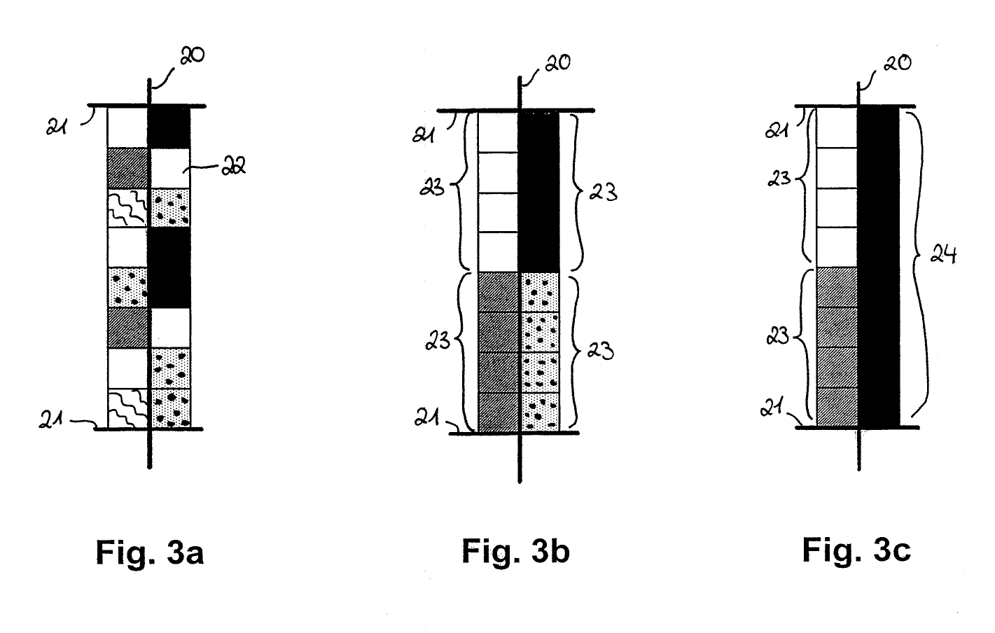

In the following the image analysis and the detailed components of the image analyser 4 will be explained with reference to FIG. 2. In FIG. 2 an image analyser 4 is exemplary shown, whereby the configuration of the horizontal image analyser 4a apart from the different analysing direction corresponds to the configuration of the vertical image analyser 4b.

In the following the description will be made with reference to a vertical block boundary, i.e. the decision and analysis process is valid for a block boundary between two horizontal adjacent blocks. However, the present invention is not limited to the vertical block boundary but can be of course applied to a horizontal block boundary with a corresponding amendment of the features. That means the vertical analysis and the horizontal analysis is analogous.

The image analysis comprises three basic processes, namely

1. per pixel feature detection
2. partial block smoothing
3. per block feature detection.

For this purpose the image analyser 4 comprises a pixel feature detector 40, a smoothing filter 41 and a per block feature detector 42.

The per pixel feature detector 40 detects features of pixels adjacent and/or neighboring to block boundaries. Dependent on the detected features the per pixel feature detector 40 assigns different values to the detection map at the position of the pixels adjacent to every block boundary and outputs this first intermediate detection map 11 to the smoothing filter 41.

The smoothing filter 41 accomplishes a detection map smoothing of parts of the block adjacent to the block boundary, i.e. the smoothing filter 41 does not smooth a complete block but smoothes a partial block adjacent to the block boundary and for the smoothing also can use different filters. After the smoothing previously assigned values within the detection map are correspondingly changed and a second intermediate detection map 12 is output to the per block feature detector 42.

The per block feature detector 42 detects features of partial blocks adjacent to block boundaries. Hereby, the partial block analysed by the per block feature detector 42 in size and/or position can correspond to or be different from the partial block which was previously smoothed by the smoothing filter. After having detected these features, the per block feature detector 42 can also modify the detection map and finally output the map information 13.

In the following the above-mentioned processes, i.e. the per pixel mode decision, the partial smoothing and the per block mode decision will be explained in detail.

### 1. Per Pixel Feature Detection

The pixel feature detector 40 comprises a flat versus detail discriminator 401 (in the following referred to as FD discriminator 401) and a block boundary gradient measure unit 402 (in the following referred to as BBGM unit 402).

The main function of the FD discriminator 401 is to distinguish detailed areas from homogeneous areas on either side of a block boundary. The result of the FD processing is written to the so-called detection map, whereby in the present invention a different detection map is created for vertical block boundaries and for horizontal block boundaries. The output map information, which is also referred to as detection map, in case of the vertical output map information is also referred to as outDetMapVer and in case of the horizontal output map information is also referred to as outDetMapHor.

In order to assign a value to a pixel adjacent to a block boundary, the FD discriminator 401 calculates differences between the pixel adjacent to the block boundary and pixels in the vicinity of the pixel adjacent to the block boundary. More specifically, the FD discriminator calculates differences between two adjacent pixels within a group of pixels within a line or column, whereby the group of pixels includes the pixel adjacent to the block boundary and one or more pixels within the same line or same column.

The calculated differences are then compared against a predefined threshold and if the difference is above the threshold, then for each difference a counter is incremented and the final count value is then assigned to the detection map at the position of the pixel adjacent to the block boundary.

In the following a detailed example is given, whereby a grid of 8×8 pixels is assumed, meaning that every eighth pixel in horizontal and vertical direction is a block boundary. Some of the pixels in the vicinity of such a block boundary might be degraded showing a blocking artefact. In a preferred embodiment the implementation of the invention uses a fixed block grid of 8×8 pixels, e.g. MPEG 2, but in a more generic implementation the present invention is not limited to a fixed block grid with a fixed size.

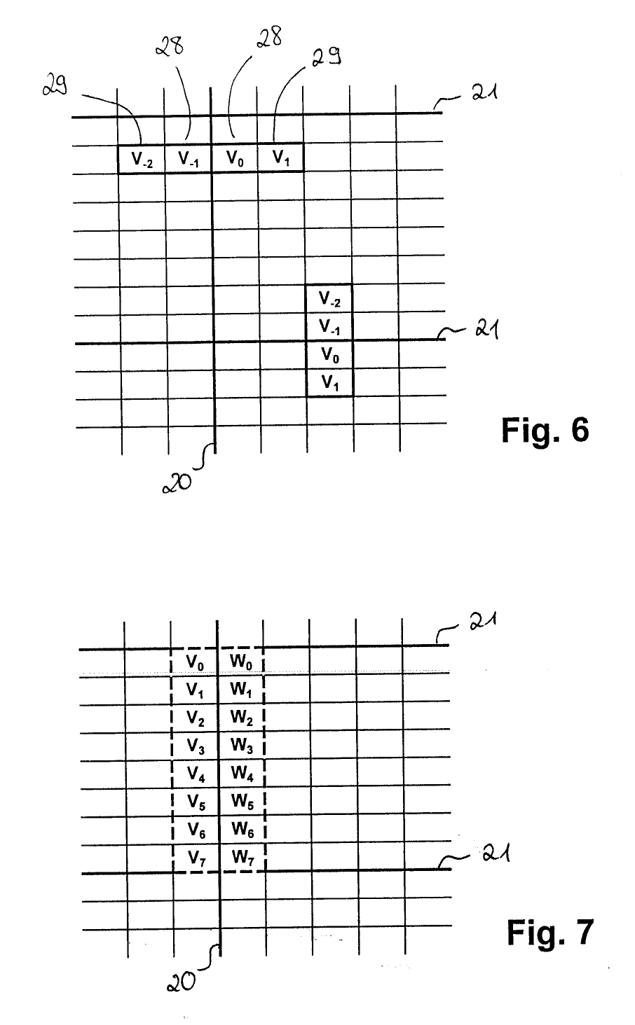

The detailed processing is explained with reference to FIG. 4. In FIG. 4 an image having a grid of 8×8 pixels is shown and the vertical block boundary is indicated with 20 and the horizontal block boundary is indicated with 21. In the following the process will be explained with reference to pixels adjacent to the vertical block boundary 20.

In order to determine the value to be assigned to each pixel 25 adjacent the vertical block boundary 20, at least one neighbouring pixel 26 within the same line of the same block is selected. In the present implementation three neighbouring pixels 26 are selected.

In the following the differences between every two adjacent pixels of the selected group of pixels are calculated, i.e. the differences between pixels v₀ and v₁, v₁ and v₂, v₂ and v₃ are calculated. Each of the pixel differences is then compared with a predefined threshold T2 and for each pixel difference being above the threshold, a counter is increased by one. The value of the counter is then assigned to the detection map at the position of the pixel 25 adjacent the block boundary 20.

In the following the process steps are again explained for the example of a pixel at a position right from the vertical block boundary 20, i.e. the following is an exemplary description of the FD discrimination for the vertical block boundary in the case of using three neighboring pixels 26.

Step 1: Calculate 3 absolute pixel differences right from vertical block boundary:

diffₙ=|vₙ−vₙ₊₁|

In the present example using three neighbouring pixels, n is running from 0 to 2. But the present invention is not limited to the number of three neighbouring pixels, but comprises also other numbers of neighbouring pixels, e.g. one, two, four or more.

Further, if in the present invention pixel differences are computed, this is intended to refer to the absolute pixel difference.

Step 2: Compare each difference against a threshold thresh_detail (T2). If the difference is above the threshold, increase detail counter countR for the pixel position right from the block boundary 20:

if (diffₙ>thresh_detail)

then

countR++

Step 3: Assign value of countR to detection map at pixel position right from vertical block boundary

Step 4: Perform steps 1.-3. for all other pixels right from block boundary and for all pixels left from vertical block boundary in an analogous manner.

Therefore in this particular implementation three pixel differences on the left and right side are calculated, which are compared against a threshold (thresh_detail). The number of pixel differences used for FD discrimination is in a generic implementation not fixed. But it should address only pixels within a certain neighbourhood of the block boundary. If difference is above this threshold the respective counter for details (countL, countR) is incremented. The value of countL is in the last step assigned to the detection map at position left from the block boundary. The value of countR is assigned analogously. The maximum value of countR, countL in this particular implementation is 3 if all differences are above thresh_detail. In a more generic implementation the maximum value of countL, countR is defined by the number of pixel differences used. The minimum value of countR, countL is 0 if all differences are below thresh_detail. A possible value for T2 could lie between 3 and 10 and preferably is about 5, but the present invention is not limited to this specific values.

The corresponding detection map is then submitted to the BBGM unit 402.

The BBGM process is a detection mechanism for gradient like luminance distribution across the block boundary. It is used to account for possible misdetections from the prior FD discrimination step. The result of the BBGM process is also written to the detection map.

For the BBGM process the same pixels are used which were already used for the FD discrimination process. Hereby in a first step an average value over the absolute pixel differences is calculated. Then the difference between the pixels on both sides of the block boundary and the average of the differences is calculated. A fixed value, in the present example 4, is then assigned to the position of the pixel adjacent to the block boundary in case that two conditions are fulfilled, i.e. that firstly the difference between difference at block boundary and average is below a predefined threshold and that secondly the average is above a predefined threshold.

The process of the BB gradient measure for the case of a vertical block boundary 20 using both pixels 25 adjacent to the block boundary on the left and right side and three neighbouring pixels 26 will be explained in more detail in the following. I.e. for the exemplary explanation of the BB gradient measure the pixels indicated in FIG. 4 with v₋₄, v₋₃, v₋₂, v₋₁, and v₀ are used.

Step 1: Calculate average value over 3 pixel differences left from vertical block boundary:

avg=(|v₋₄−v₋₃|+|v₋₃−v₋₂|+|v₋₂−v₋₁|)/3

Step 2: Calculate difference between difference at block boundary and average of differences:

gradSim=∥v₋₁−v₀|−avg|

Step 3: Assign value of countL to 4 (detail case of a short filter) at position left from vertical block boundary in case following conditional is met:

if ((enable)&&(gradSim<thresh_gradSim)&&(avg>thresh_gradMean)) countL=4

The condition (enable) hereby indicates the possibility to switch the BBGM unit 402 off, i.e. the above value is only assigned to the pixel if in addition to the before mentioned two conditions also the whole process is set to the condition enable.

Step 4: Perform steps 1.-3. for all other pixels left from vertical block boundary 20 and for all pixels right from vertical block boundary 20.

Therefore in this particular implementation the average over three pixel differences left from vertical block boundary is calculated. In a more generic implementation the number of pixel differences taken into account is not limited and can be any number between 2 and width (or height) of underlying block. In a second step the difference between avg and the difference at the block boundary is calculated. As a last step the value of gradSim is compared against some thresholds. The threshold value thresh_gradSim accounts for the admissible difference between gradient at block boundary and left/right from block boundary (gradient similarity). The threshold value thresh_gradMean represents the minimum average value of gradient adjacent to the block boundary (gradient mean). Based on the comparison the value of detection map is either set to 4 or left untouched. The processing for right side of block boundary is analogous.

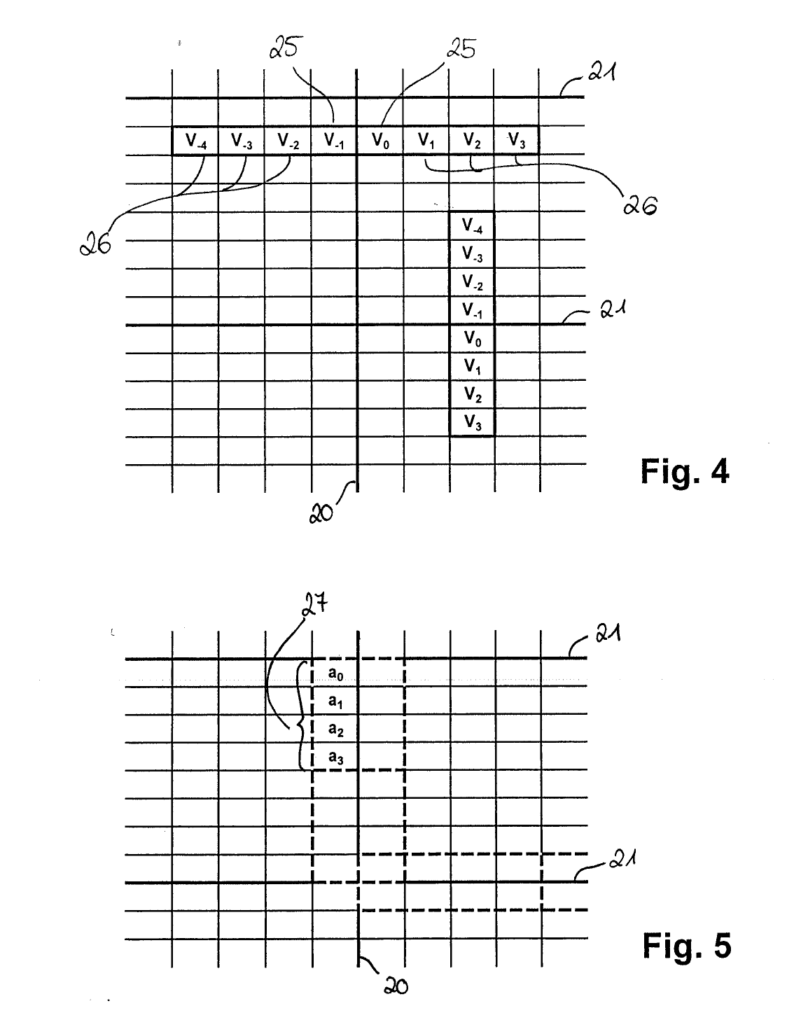

The resulting detection map is then output by the pixel feature analyser 40 as first intermediate map information 11 to smoothing filter 41. An example of such a detection map after the pixel feature detector 40 is shown in FIG. 3a. As can be seen to all pixels in the detection map 22 adjacent to the vertical block boundary 20 a value is assigned, whereby in FIG. 3a the different values are shown with different symbols within the pixels 22.

### 2. Partial Block Smoothing

The partial block smoothing is used to filter the results of the pixel feature detection and make the results more robust against outliers and misdetections.

For the partial block smoothing a block of at least two pixels each being adjacent to a block boundary is used. In a preferred implementation the partial block smoothing is a half block smoothing limited to an area of 4×1 pixels, i.e. a block of four pixels each adjacent the block boundary, but in a more generic implementation the partial block smoothing is not limited to a fixed size. However, in a preferred embodiment it is recommended to set the value equal to half of the block size.

The half block smoothing is explained with reference to FIG. 5, where in the exemplary embodiment a partial block 27 of 4×1 pixels adjacent to the vertical block boundary 20 and on the left side of the vertical block boundary 20 is used.

For the partial block smoothing the maximum value over the pixels within the partial block is calculated. Then a median filtering is performed, determining the median value between the value of the four pixels within the partial block and the previously calculated maximum value. The output of the median filter operation is then assigned to all pixels within the block.

The process is shown in more detail with reference to FIG. 5, where the four pixels a₀ to a₃ are used.

In the following the operation of the smoothing filter 41 is explained in more detail for the case of a vertical block boundary 20 and a partial block 27 having a size of four pixels:

Step 1: Calculate maximum value over pixels a₀, a₁, a₂, a₃ within partial block 27 (in the present example the top four pixels)

maxVal=MAX(a₀,a₁,a₂,a₃)

Step 2: Perform median filtering over all pixels a₀, a₁, a₂, a₃ and the previously calculated maximum value as follows

medVal=MED(a₀,a₁,a₂,a₃,maxVal)

Step 3: Assign output of median filter operation to all pixels a₀, a₁, a₂, a₃ within partial block 27

a₀=a₁=a₂=a₃=medVal

Step 4. Perform steps 1.-3. for bottom four pixels and both half blocks on the right from vertical block boundary.

The half block smoothing process first finds maximum value maxVal for the half block left to the block boundary. In a second step in this particular implementation a 5-tap median is applied using the four pixel values at the block boundary and the maximum value maxVal to determine and assign the new value of the detection map for the particular 4×1 area. In a more generic implementation the candidates for the median filter should include all pixels of the partial block belonging to the respective side of the block boundary. The number of taps for the median filter is in a more generic implementation equal to half of the block size plus one. The concept of median filtering is applied to smooth single outliers. A special emphasis in the median is put on the maximum value for a simple reason. The values of the detection map stem from the FD discrimination and/or BBGM process respectively. If one of the processes assigns a high value to the detection map this should be emphasized. A high value in detection map would result later in selection of short deblocking filter or bypass of filter, implying less loss of detail. Evaluation has proven merit of using maxVal in the median from an image quality point of view. In some cases it is a safe fallback mechanism to use short filter or simply bypass if per pixel decision map shows many different values for parts of the respective block. The processing for right side of block boundary is analogous.

An example of an output map, i.e. second intermediate map information 12 is shown in FIG. 3b. As can be seen, the same value is assigned to each block 23 of 4×1 pixels adjacent to the vertical block boundary 20.

The second intermediate map information 12 is then submitted to the block feature detector 42. It is to be noted that also other smoothing techniques are possible, e.g. mean filtering, maximum filtering, weighted median or the like.

### 3. Per Block Feature Detection

The per block feature detection is used to make the results of the half block smoothing more robust. Therefore a feature analysis for the whole vertical or horizontal block boundary is applied. This analysis is separated into three different steps.

The first step is accomplished by the block boundary gradient analysis unit 421 (in the following referred to as BBGA unit 421). The next step is carried out by the block boundary contingency analysis unit 422 (in the following referred to as BBCA unit 422). The third step is carried out by the block boundary step height control unit 423 (in the following referred to as BBSH unit 423)

The main target of the BBGA process is to refine and update the detection map as a post processing to partial block smoothing on a per block basis. The gradient analysis assigns a content class, e.g. detail or real edge area, on both sides of the block boundary. The result is written to the detection map on a per block basis.

The BBGA process will be explained with reference to FIG. 6. For the BBGA for the analysis of a vertical block boundary 20 pixels within a row are selected and for analysis of a horizontal block boundary 21 pixels within a column are selected. Hereby, the two pixels adjacent the block boundary and at least two further pixels within the same row or column adjacent to the other pixels are selected. The number and position of the selected pixels on each side of the block boundary is symmetric with respect to the bock boundary.

A first main gradient, i.e. the absolute difference between the two pixels 28 directly adjacent the block boundary 20 is calculated. Then the difference between the two pixels being neighbouring pixels 29 to the pixels 28 adjacent to the block boundary 20 is calculated as second main gradient. This is done for every pixel group along the block boundary within one block. Then the sum over the first and second main gradients is calculated and then different values are assigned to the detection map depending on the values of the summed up gradients.

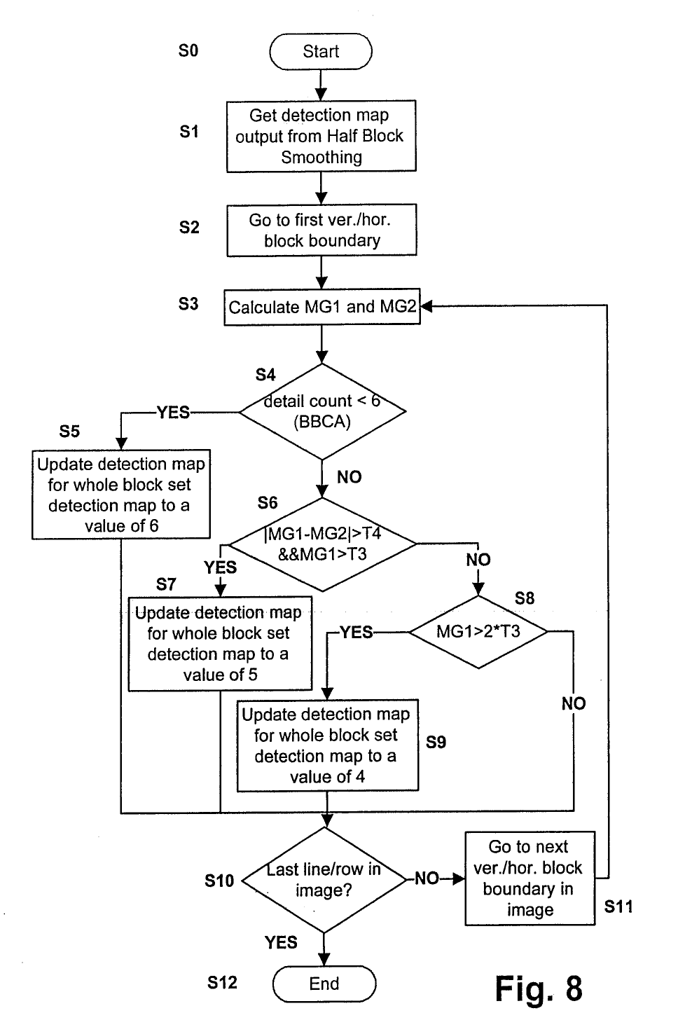

This is explained in more detail with reference to the flow chart of FIG. 8 and the corresponding description.

The process starts in step S0. In step S1 the detection map output, i.e. the second intermediate map information 12 is received from the smoothing filter 41. Then the process in step S2 goes to the first vertical or horizontal block boundary to be analysed.

In step S3 the first and second main gradients for pixels directly adjacent to the block boundary are calculated for each row of the block.

mg1(y)=|v(y)⁻¹−v(y)₀|(first main gradient)

mg2(y)=|v(y)₋₂−v(y)₁|(second main gradient)

and then the sum over first and second main gradients are calculated in order to receive the values of MG1 and MG2.

$$MG 1 = {\sum }_{i = 0}^{7} mg 1 ( i ) ( sum over first main gradients )$$

$$MG 2 = {\sum }_{i = 0}^{7} mg 2 ( i ) ( sum over second main gradients )$$

With the calculated sum over first and second main gradients along the block boundary the process continues as follows. MG1 and MG2 are used to assign content classes to the detection map. The analysis is in this particular implementation of the invention based on the sum over first and second main gradients but can in a more generic implementation be replaced with a different analysis component, which is able to distinguish detail from real edge.

In step S4 a first condition is checked. This conditional is explained in the Block Boundary Contingency Analysis paragraph. Its main target is to decide whether a block boundary is subject to show blocking artefact or does not show blocking artefact at all. In the present example the condition “detail count<6” is used, but any number other than 6 can be used.

In step S6 a second condition is checked. This conditional compares the absolute difference between MG1 and MG2 with a threshold T4 and compares MG1 against a threshold T3. The main target of this conditional is to decide whether a real edge gradient is apparent across the block boundary. It is assumed that a real or natural edge gradient is spread across the block boundary, while a blocking artefact escalates across block boundary with a very narrow elongation. This issue is addressed in the first expression of the second condition. In case of an ideal jump function or a blocking artefact at the block boundary, MG1 and MG2 are very similar resulting in a small absolute difference of MG1 and MG2. In case of a real edge at the block boundary, MG2 is greater than MG1 resulting in a high absolute difference of MG1 and MG2. Thus it is possible to distinguish a real edge from a blocking artefact using the first expression in the second condition.

The second expression of the second condition is used to decide whether the block boundary is identical with a high transition in luminance level (e.g. object border). The probability that such a high transition is due to strong quantization is very low. Thus it is safe to assume an object border in this particular case. If the second condition is fulfilled the detection map in step S7 is set to a value of 5 for both sides of the whole block boundary.

The third condition checked in step S8 compares MG1 against a threshold value 2*T3. It is a stronger form of the second expression of conditional in step S6. Its main target is to decide whether the block boundary is identical with a high transition in luminance level. If the third condition is fulfilled the detection map in step S9 is set to a value of 4 for both sides of the whole block boundary.

In step S10 it is checked, whether the last line or row within the image is reached. If this is not the case, then the process according to step S11 continues with the next vertical or horizontal block boundary in the image. Otherwise, the process ends in step S12.

The next process is accomplished by the block boundary contingency analysis unit 422 (in the following referred to as BBCA unit 422).

The Block Boundary Contingency Analysis (BBCA) is used to override the detection map refinement from the smoothing filter 41 on a block basis (shown in flow diagram FIG. 8 as first condition in step S4), if the number of differences across block boundary which are greater than zero is below a threshold detail_count. If the first condition is met, the detection map in step S5 is set to a value of 6 for both sides of the block boundary. This means there are too few pixel differences higher than the threshold where blocking artefact is assumed. Thus there should be no blocking artefact visible.

The BBCA process is shown with reference to FIG. 7. Hereby the differences between two pixels on different sides of a block boundary, in the present example the vertical block boundary 20, are calculated. If the number of differences is below a certain threshold then it is assumed that no blocking artefact is apparent and no filter is applied but a bypass is provided.

In the following the BBCA process is explained in more detail.

Step 1: Count number of differences at block boundary which are above 0:

if (|vᵢ−wᵢ|>0)

detail_count++

Step 2: If detail_count is less than 6, it is assumed that no blocking artefact is apparent and no filter is applied, i.e. a bypass filter mode is selected:

if (detail_count<6)

do not filter block border (bypass)

This threshold value 6 is used in the preferred implementation but any other threshold than 6 can be used as well.

The next process is accomplished by the block boundary step height control unit 423 (in the following referred to as BBSH unit 423). The BBSH is used to control the impact of the blocking filter. Based on a simple comparison of the previously calculated sum of absolute differences between pixels directly adjacent to a block boundary against a predefined threshold value the detection map is set to a value signaling a bypass for the whole block boundary.

The detailed process is explained in the following.

Step 1: Calculate sum of absolute differences (SAD) between pixels adjacent to block border and store result as MG1:

$$MG 1 = {\sum }_{i = 0}^{7} \vert ( {v}_{i} - {w}_{i} ) \vert$$

Step 2: Compare MG1 against threshold_deblocking. Deblocking is only active, if boundary step height is equal or above threshold_deblocking:

if (MG1≦255−threshold_deblocking)*blckSz)

do not filter block border (bypass)

Hereby, the different parameters can be set to different values depending on the actual needs. The threshold deblocking value can be adjusted between 0 . . . 255, whereby 0 means a bypass which blocks up to maximum step height of 255. 255 means no bypass and any step height will be filtered (according to internal analysis). In a preferred embodiment the default value is 255, i.e. no bypass.

Afterwards the final map information 13 is output by the block feature detector 42. An example of such a map information is given in FIG. 3c. It can be seen that for two half blocks 23 on one side of the block boundary 20 different values are assigned, whereby for one entire block 24 adjacent the block boundary 20 one value is assigned.

In the following a table will visualize the values of the detection map and provide a corresponding explanation.

| Value of | |
|---|---|
| detection map for | |
| one direction | Analysis Statement |
| 0, 1 | block artefact between homogeneous blocks |
| 2, 3, 4 | block artefact between non-homogeneous blocks |
| 5 | real edge between blocks |
| 6 | no block artefact at block boundary (too many |
| | different pixel values, less than 2 pixels refer to a |
| | blocking artefact in this block, for the other pixels |
| | the difference at the block border is zero) |
| 7 | no block artefact (initialization value) |

Hereby, for the final visualization the detection maps from horizontal and vertical processing are summed up.

The map information 13, i.e. the detection map, is then employed to adapt the deblocking filters in horizontal and vertical direction. In one particular implementation, two filter types are used, so that for each direction either a long deblocking filter (for homogeneous areas) or a short deblocking filter (for detail areas) is applied. The present invention further provides also a bypass. The adaptive filter selection strategy is based on the value of a detection map as will be explained in the following.

The values on both sides of a block boundary indicate detailed areas or homogeneous areas and therefore by providing different conditions, the long filter, the short filter or the bypass can be selected. An example of a filter selection according to the values of the detection map is given in the following table.

| Value of detection map | Deblocking Filter |
|---|---|
| A <= 1&&B <= 1 | Long Filter |
| (A < 5)&&(B < 5) AND “long filter | Short Filter |
| condition not fulfilled” | |
| else | Bypass |

Hereby A means the detection result left or top to the block boundary and B means the detection result right or bottom to block boundary.

In the following, the different filter types will be explained in detail.

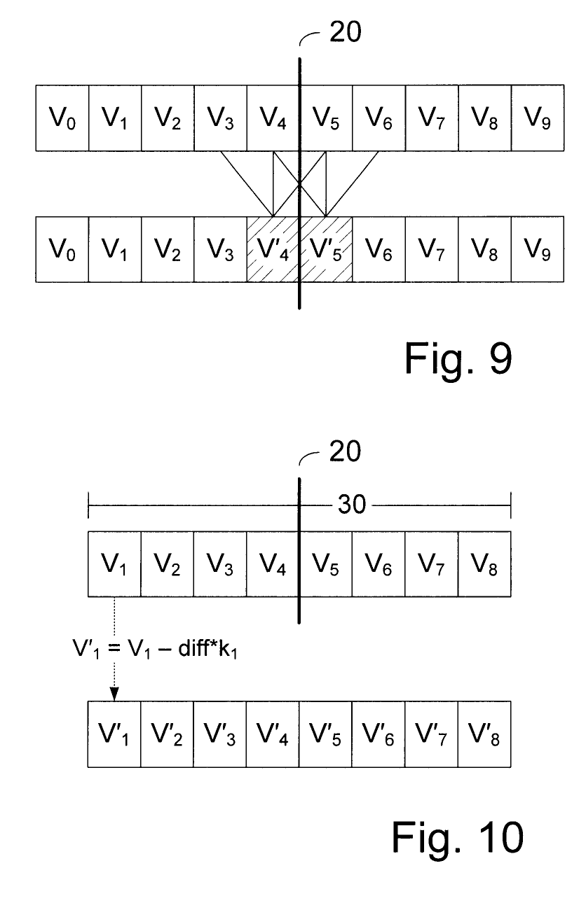

The short deblocking filter is a simple 3-tap FIR filter with coefficients [0.15; 0.7; 0.15]. The current short filter is a very simple but quite effective FIR low-pass filter realization. In a more generic implementation of this invention the FIR filter might not be limited to a 3-tap realization. It is also possible to adapt the filter coefficients e.g. according to the bit rate, or the overall image quality. The filter is shown in FIG. 9.

The two pixels (v₄, v₅) directly adjacent to the block boundary are replaced with the result of a 3-tap FIR filter according to the following equations:

v′₄=0.15(v₃+v₅)+0.7v₄

v′₅=0.15(v₄+v₆)+0.7v₅

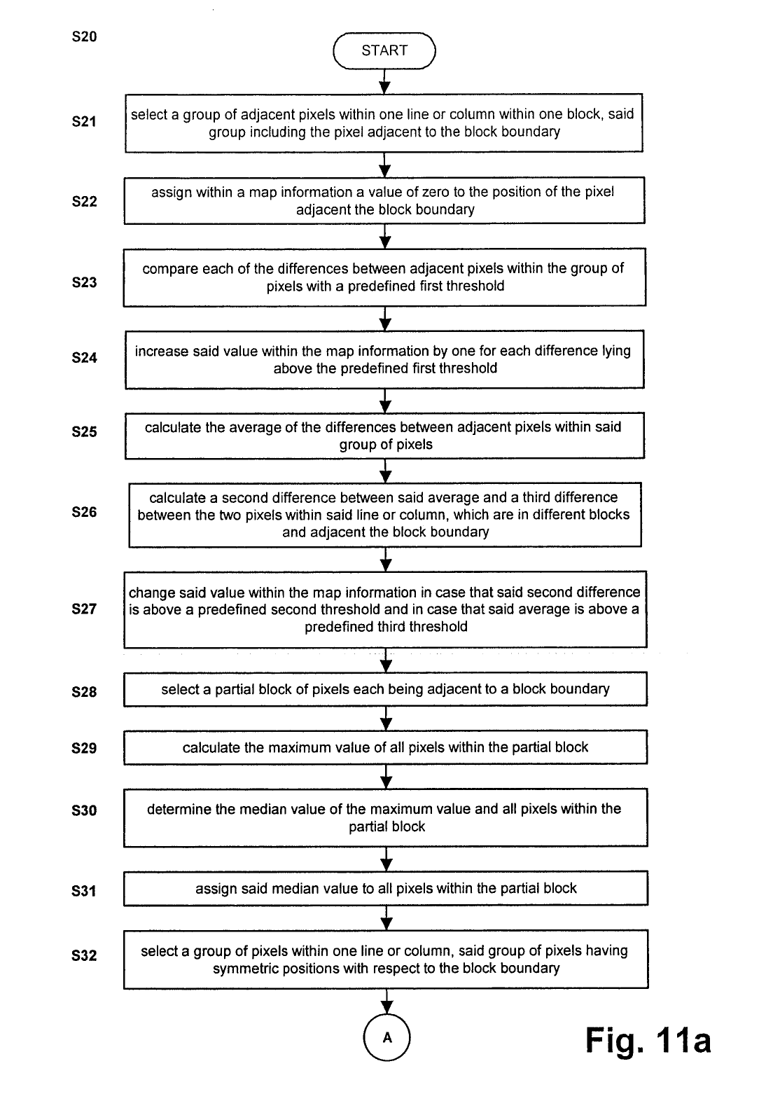

The long deblocking filter will be explained in the following. The filter kernel used for the homogeneous areas is more elongated in comparison to the detail filter. It also uses more pixel values for deblocking filtering. The filter is also shown in FIG. 10, where the active filter region is indicated with 30.

The steps for using the long filter are as follow:

Step 1: Calculate pixel difference at block boundary and define coefficient set k:

$$diff = {v}_{4} - {v}_{5}$$

$$k = ( \frac{1}{9} , \frac{2}{9} , \frac{3}{9} , \frac{4}{9} , \frac{4}{9} , \frac{3}{9} , \frac{2}{9} , \frac{1}{9} )$$

Step 2: Replace each of the 4 pixels left from block boundary (v₁, v₂, v₃, v₄) with the result of the following equation:

v′ᵢ=vᵢ−diff·kᵢ and i[1 . . . 4]

Step 3: Replace each of the 4 pixels right from the block boundary (v₅, v₆, v₇, v₈) with the result of the following equation:

v′ⱼ=vⱼ+diff·kⱼ and j[5 . . . 8]

An example of the final map is shown in FIG. 3c. The map information for pixels within two half blocks 23 on one side of the vertical block boundary 20 has the same value and the map information for pixels within one entire block 24 on the other side has the same value.

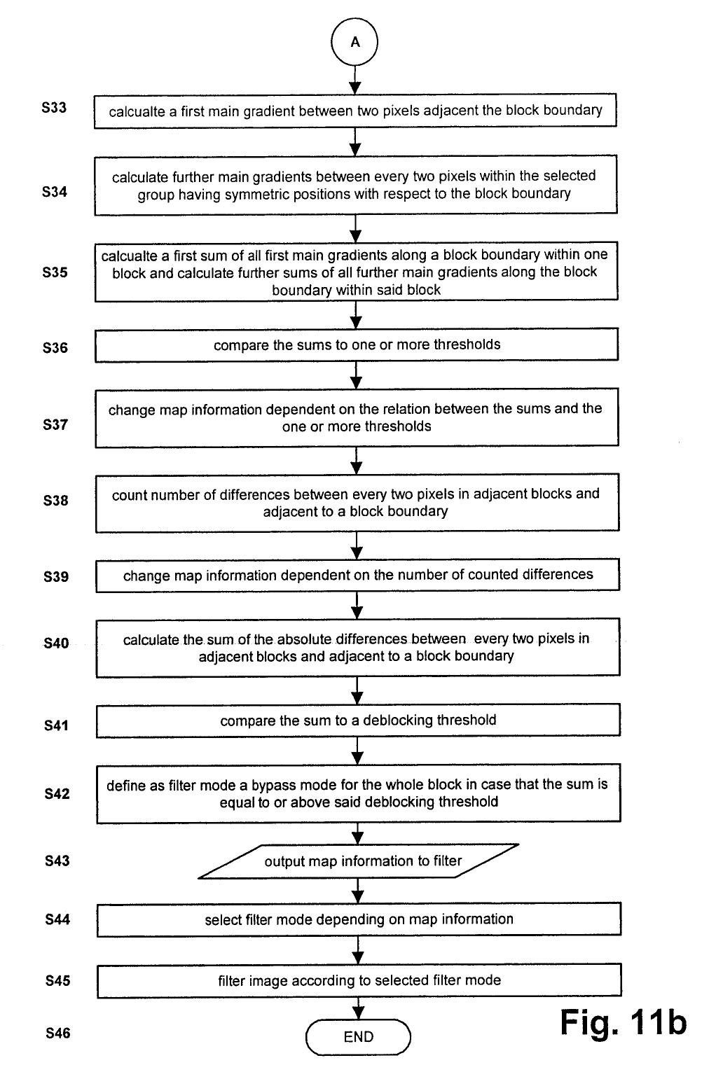

In the following, the complete process according to the method of the present invention will be explained with reference to FIGS. 11a and 11b.

The process starts in step S20. In the next step S21 a group of adjacent pixels within one line or column within one block is selected, said group including the pixel adjacent to the block boundary. In step S22 within a map information a value of zero is assigned to the position of the pixel adjacent the block boundary. In step S23 each of the differences between adjacent pixels within the group of pixels is compared with a predefined first threshold. In step S24 said value within the map information is increased by one for each difference lying above the predefined first threshold.

In step S25 the average of the differences between adjacent pixels within said group of pixels is calculated and in step S26 a second difference is calculated between said average and a third difference between the two pixels within said line or column, which are in different blocks and adjacent the block boundary. In step S27 said value within the map information is changed in case that said second difference is above a predefined second threshold and in case that said average is above a predefined third threshold.

In step S28 a partial block of pixels each being adjacent to a block boundary is selected. In step S29 the maximum value of all pixels within the partial block calculated, in step S30 the median value of the maximum value and all pixels within the partial block is determined and in step S31 said median value is assigned to all pixels within the partial block.

In step S32 a group of pixels within one line or column is selected, said group of pixels having symmetric position with respect to the block boundary. In step S33 a first main gradient between two pixels adjacent the block boundary is calculated and in step S34 further main gradients are calculated for every two pixels within the selected group having symmetric position with respect to the block boundary. In step S35 a first sum of all first main gradients along a block boundary within one block is calculated and further sums of all further main gradients along the block boundary within said block are calculated. In step S36 the several sums are compared to one or more thresholds and in step S37 the map information is changed dependent on the relation between the sums and the one or more thresholds.

In step S38 the number of differences between every two pixels in adjacent block and adjacent to a block boundary are counted and in step S39 the map information is changed dependent on the number of counted differences.

In step S40 the sum of the absolute differences between every two pixels in adjacent block and adjacent to a block boundary, is calculated and in step S41 compared to a deblocking threshold. In step S42 as filter mode a bypass mode for the whole block is defined in case that the sum is equal to or above said deblocking threshold.

The map information is then output in step S43 to the filter, which in step S44 selects the filter mode depending on the map information. Hereby, different filter modes are selected for different block boundaries or even different filter modes are selected for parts of block boundaries within the same block. In step S45 the image is filtered according to the selected filter mode.

The process ends in step S46.

To summarize, the proposed adaptive deblocking method features a simple and effective image content analysis. Simultaneously it delivers better artefact reduction than state of the art methods. The new approach is coding parameter independent (e.g. quantization level) and can thus be employed more flexible (e.g. as post-processing). In comparison to the known methods it is less computational complex, as it does not use divisions or IDCT. This could be of merit in terms of a more efficient hardware realization. Moreover, the robustness of blocking artefact detection is increased (e.g. Partial Block Smoothing, BBGM, BBGA, BBCA, FD Discrimination).

The present system, method and computer program product can specifically be used when displaying images in non-stroboscopic display devices, in particular Liquid Crystal Display Panels (LCDs), Thin Film Transistor Displays (TFTs), Color Sequential Displays, Plasma Display Panels (PDPs), Digital Micro Mirror Devices or Organic Light Emitting Diode (OLED) displays.

The above description of the preferred embodiments of the present invention has been provided for the purposes of illustration and description. It is not intended to be exhaustive or to limit the invention to the precise forms disclosed. Many modifications and variations will be apparent to the practitioner skilled in the art. Embodiments were chosen and described in order to best describe the principles of the invention and its practical application, thereby enabling others skilled in the art to understand the invention, the various embodiments and with various modifications that are suited to the particular use contemplated.

Although the invention has been described in language specific to structural features and/or methodological steps, it is to be understood that the invention defined in the appended claims is not necessarily limited to the specific features or steps described. Rather, the specific features and steps are disclosed as preferred forms of implementing the claimed invention.

1. A method for reduction of blocking artefacts in a compressed image or video signal, comprising the steps of
analyzing the image in the vicinity of the block boundaries in order to measure the existence and strength of blocking artefacts and to detect image areas,
generating map information for each pixel adjacent to a block boundary based on the analysis result,
determining the filter mode for each block boundary dependent on the map information, and
filtering the image depending on the chosen filter mode.

2. The method according to claim 1,
wherein the detection of image areas comprises detection of edges, textured areas and homogeneous areas within the image.

3. The method according to claim 1,
wherein as filter mode a long deblocking filter, a short deblocking filter or a bypass are provided.

4. The method according to claim 1,
wherein the analyzing step comprises the steps of
detecting features of pixels adjacent to block boundaries,
smoothing map information of partial blocks adjacent to block boundaries, and
detecting features of partial blocks adjacent to block boundaries.

5. The method according to claim 4,
wherein the step of detecting features of pixels adjacent to block boundaries comprises
selecting a group of adjacent pixels within one line or column within one block, said group including the pixel adjacent to the block boundary, and
generating map information based on the absolute differences between two adjacent pixels of the group of pixels.

6. The method according to claim 5,
wherein the step of generating map information based on the absolute differences between two adjacent pixels of the group of pixels comprises
assigning within the map information a value of zero to the position of the pixel adjacent the block boundary,
comparing each of the absolute differences between adjacent pixels within the group of pixels with a predefined first threshold, and
increasing said value within the map information by one for each absolute difference lying above the predefined first threshold.

7. The method according to claim 6,
wherein the step of generating map information based on the absolute differences between two adjacent pixels of the group of pixels further comprises
calculating the average of the absolute differences between adjacent pixels within said group of pixels,
calculating a second absolute difference between said average and a third absolute difference between the two pixels within said line or column, which are in different blocks and adjacent the block boundary, and
changing said value within the map information in case that said second absolute difference is above a predefined second threshold and in case that said average is above a predefined third threshold.

8. The method according to claim 4,
wherein the step of smoothing map information in a partial block comprises
selecting a partial block of pixels each being adjacent to a block boundary and
assigning a common value to all pixels within the partial block.

9. The method according to claim 8,
wherein the step of assigning a common value comprises
calculating the maximum value of all pixels within the partial block,
determining the median value of the maximum value and all pixels within the partial block, and
assigning said median value to all pixels within the partial block.

10. The method according to claim 4,
wherein the step of detecting features of partial blocks adjacent to block boundaries comprises
selecting a group of pixels within one line or column, said group of pixels having
symmetric position with respect to the block boundary and
generating map information based on the differences between every two pixels being symmetric to the block boundary.

11. The method according to claim 10,
wherein the step of generating map information comprises
calculating a first main gradient between two pixels adjacent to the block boundary,
calculating further main gradients for every two pixels within the selected group having symmetric position with respect to the block boundary,
calculating a first sum of all first main gradients along a block boundary within one block and calculating further sums of all further main gradients along the block boundary within said block,
comparing the several sums to one or more thresholds and
generating map information dependent on the relation between the sums and the one or more thresholds.

12. The method according to claim 10 or 11,
wherein the step of detecting features of partial blocks adjacent to block boundaries further comprises
counting the number of differences between every two pixels in adjacent block and adjacent to a block boundary and
generating map information dependent on the number of counted differences.

13. The method according to claim 10,
wherein the step of detecting features of partial blocks adjacent to block boundaries further comprises
calculating the sum of the absolute differences between every two pixels in adjacent block and adjacent to a block boundary,
comparing the sum to a deblocking threshold and
defining as filter mode a bypass mode for the whole block in case that the sum is equal to or above said deblocking threshold.

14. A system for reduction of blocking artefacts in compressed image and video signals,
an analyzer for analyzing the image in the vicinity of the block boundaries in order to measure the existence and strength of blocking artefacts and to detect image areas and for generating map information for each pixel adjacent to a block boundary based on the analysis result, and
a filter which is adapted to determine the filter mode for each block boundary dependent on the map information and to filter the image depending on the chosen filter mode.

15. A system for reduction of blocking artefacts in compressed image and video signals,
an analyzing means for analyzing the image in the vicinity of the block boundaries in order to measure the existence and strength of blocking artefacts and to detect image areas,
a generating means for generating map information for each pixel adjacent to a block boundary based on the analysis result, and
a filtering means for determining the filter mode for each block boundary dependent on the map information and to filter the image depending on the chosen filter mode.

16. A computer program product stored on a computer readable medium which causes a computer to perform the steps of
analyzing the image in the vicinity of the block boundaries in order to measure the existence and strength blocking artefacts and to detect image areas,
generating map information for each pixel adjacent to a block boundary based on the analysis result, determining the filter mode for each block boundary dependent on the map information, and
filtering the image depending on the chosen filter mode.
